(19) United States
(12) Patent Application Publication
(10) Pub. No.: US 2026/0344970 A1
(43) Pub. Date: Nov. 5, 2026

(54) Space-saving device with automatic opening function for opening and closing a dishwasher door

(71) Applicant: Elettrotecnica Rold Srl

(72) Inventors: Stefano Rocchitelli, Nerviano (MI) (IT); Vito Masi, Nerviano (MI) (IT); Luca Trentini, Nerviano (MI) (IT); Ivano Ezio Lombardi, Nerviano (MI) (IT)

(21) Appl. No.: 19/100,102

(22) PCT Filed: Aug. 2, 2023
(86) PCT No.: PCT/IB2023/057830

§ 371 Date: Jan. 30, 2025

(30) Foreign Application Priority Data
Aug. 3, 2022 (IT) 102022000016482

(51) Int. Cl. A47L 15/42; A47L 15/46; E05B 47/00; E05B 65/00

(52) U.S. Cl. CPC A47L 15/4259; A47L 15/4274; A47L 15/46; E05B 47/0012; E05B 65/00; E05B 2047/0016; E05B 2047/0017; E05B 2047/002; E05B 2047/0068

(57) ABSTRACT

A device for opening and closing the door of a dishwasher includes a closing unit that is associated with a cross member, which houses a containment body accommodating a striker pin when it moves transversally. A closing element in the containment body is movable between closing and opening positions, in which the striker pin is respectively retained and released. A pusher is movable by an actuator to abut a striker element provided on the closing element and translates between a non-extended rest position and an extended operating position, where it exerts a thrust on the striker element causing the transverse movement of the pin. The containment body further includes a detection or sensing element that selectively closes an electrical circuit, allowing the start of a washing cycle when the sensing element is moved by the striker pin moving to the closed door position.

### FIELD OF THE INVENTION

The present invention relates to a device for automatically opening and closing the doors of household appliances, in particular dishwashers, which may be built-in, and thus there will be a built-in cabinet panel associated with the door, or free-standing.

The object of the present invention is therefore a device which, in addition to solving certain drawbacks that afflict devices of the known type that perform the automatic opening of the door, allows it to be installed inside the frame of the appliance, which does not have to be cut and is therefore not compromised in its resistance to mechanical stress.

### BACKGROUND

As is known, household appliances are generally equipped with devices and/or systems for opening and closing the loading door, which essentially comprise an actual closing (and opening) unit, which is usually associated with the appliance frame, and a striker element, such as a latch, hook or pin, usually attached to the door.

The closing and opening unit generally comprises, according to solutions known from the state of the art, a closing element such as a hook shaped like a “U” or a latch, commonly called a “wheel”, switchable by rotation between a first opening position in which it is positioned and arranged to receive the striker pin and be engaged and rotated by the striker pin on the door, and a second closed position in which the closing hook retains the striker pin, thereby ensuring that the door itself is closed, while, conversely, switching the closing element to the open position results in the striker pin being disengaged from the closing hook, and thus the door being able to be opened.

Further, in the case of dishwashers, devices and/or systems for opening and closing the loading door have been known to be configured to perform the “push-to-open” function, i.e. in which the switching of the closing and opening element from the closed position to the open position, which allows the door to be opened, is achieved by the user exerting a push on the door itself. In systems of this type, there are also striker solutions and/or devices for checking that the door is actually closed, as well as closing systems for closing the door in the closed position.

Also known are devices and/or systems of the “pull-to-open” type, i.e. in which the switching of the closing and opening element from the closed position to the open position, which allows the door to be opened, is achieved by exerting a pull on the door by the user. Also in systems of this type, there may be striker solutions and/or devices for checking that the door is actually closed, as well as closing systems for closing the door in the closed position.

Furthermore, state-of-the-art devices and/or systems of the so-called “automatic opening” type are known, i.e., in which the switching of the closing and opening element from the closed to the open position, and thus the opening of the door, takes place automatically by means of electrical opening means which, at the end of the washing cycle and generally with a certain delay, electrically activate the closing and opening element, causing it to switch from the closed to the open position, and thus ultimately causing the door to open.

Lastly, closing and opening devices are known to be able to both provide the appliance with an electrical door open and door closed signal, and to receive from the appliance an electrical load used to activate the automatic door-opening function.

Closing devices and/or systems of the known type whose main functions and features are summarised herein, however, have certain drawbacks, which the present invention aims to solve.

In particular, the known type of closing devices and/or systems used in dishwashers generally provide that the closing unit is only partially housed in the upper cross member of the front portion of the frame facing the door of the appliance, also having a footprint in the direction Y, i.e. in the direction of the transverse axis T of the cross member, and that the striker element fixed to the door is constituted by a pin interacting with the closing element of said closing unit.

The footprint in the transverse direction of the closing unit, according to what is shown in the enclosed FIG. 1, which shows the footprint of a device of a known type and with reference to the Cartesian tern in the figure, is due to the need to perform the “automatic opening” function, which in devices of the known type is performed by an actuator that directly strikes the striker pin by exerting on said pin or on the door, a thrust in the direction Y, i.e. according to the direction of the transverse axis T of the cross member, perpendicularly to the longitudinal axis A of the cross member, which extends according to the direction X of FIG. 1, causing the striker pin to move away from the closing unit and, therefore, the opening of the door.

Since it is necessary to provide a pusher element that pushes the striker pin in the direction Y transverse to the longitudinal extension of the cross member, closing devices and/or systems of the known type generally have a footprint that cannot be contained within the width of the frame cross member, thus protruding from it in the transverse direction.

This has the disadvantage that the cross member has to be cut in order to allow the closing unit to protrude transversely as seen in FIG. 1, which results in a reduction of the cross member's bending-resistant section, which can cause deformations in the machine structure when stressed by lateral loads.

A further drawback afflicting some of the known types of closing devices and/or systems used in dishwashers is the fact that the pull-to-open function requires excessive effort on the part of the user, which is generally unwelcome to the user, who sometimes perceives the effort to be made as being caused by a fault or malfunction of the closing device.

Last but not least, a drawback afflicting the known type of closing devices and/or systems used in dishwashers concerns the risk of damage to the actuator that pushes the striker pin when the user should attempt to close the appliance door while the actuator, usually a wax actuator, is still in the extended position. In fact, it can take up to 30 seconds or more for the wax actuator to return from its extended operating position to its rest position after it has performed its automatic door-opening function by exerting its thrust against the pin; if the user attempts to close the door while the actuator is still in this extended condition, it may be damaged.

### SUMMARY OF THE INVENTION

In light of the above, it is the task of the present invention to provide an opening and closing device for dishwashers that overcomes the drawbacks that affect the known type of devices of the state of the art.

Within this task, it is the purpose of the present invention to provide a device for opening and closing the door of a household appliance, in particular a dishwasher, configured to be housed within the cross member of the frame of the appliance so as to prevent deformation of the frame structure when subjected to lateral loads, which could compromise the structural integrity of the frame and, therefore, of the appliance.

It is further an object of the present invention to provide a device for opening and closing the door of a household appliance, in particular a dishwasher, capable of operating the “pull-to-open” function which at the same time does not require excessive force from the user, in particular when closing the door, and which is particularly reliable in that it avoids the risk that the push by the user may damage the components of the device.

A further object of the present invention is to provide a device for closing and opening the door of a household appliance, in particular of a dishwasher, capable of operating at the same time the door-sensing feature, i.e. door-opening detection, the auto-opening feature, i.e. automatic opening of the door at the end of the washing cycle, the anti-tampering feature, as well as the safety feature, i.e. safety function which prevents damage to the device itself should the user try to close the door of the appliance without waiting for the reset time of the lock.

It is also the purpose of the present invention to provide a device for closing and opening the door of a household appliance with “push-to-open” feature that is compact and easy to install, as well as having “pull-to-open”, “door sensing”, “auto-opening”, “anti-tampering” and “safety” features.

This task and these and other purposes are achieved by a device for opening and closing the door of a household appliance, in particular a dishwasher, according to claim 1.

Further features of the closing and opening system according to the present invention are set forth in the dependent claims.

### LIST OF FIGURES

Further features and advantages will become clearer from the following illustrative but not limiting description of a preferred embodiment of the present invention, which will be given below with the aid of the accompanying drawings:

FIG. 1 shows a schematic view of the footprint, in relation to the cross member of the appliance frame in which it is to be housed, of a dishwasher closing device with an “auto-opening” function of a type known from the state of the art;

FIG. 2 shows an overall view of a dishwasher in which the section of the frame in which the closing device with automatic opening function is to be housed can be seen;

FIG. 3 shows a schematic view of the frame cross member in which the space-saving closing device with automatic opening function according to the present invention is housed;

FIG. 4 shows an exploded view of the opening and closing device of a dishwasher door according to the present invention in accordance with a first embodiment;

FIG. 5 shows a detail of the opening and closing device of a dishwasher door according to the present invention in accordance with the embodiment of FIG. 4 in a position corresponding to an open door condition;

FIG. 6 shows the device in FIG. 5 in a closing start condition, where the pin contacts the closing element of the device;

FIG. 7 shows the same device as in FIGS. 5 and 6 in a closed door condition;

FIGS. 8, 8A, 9 and 9A illustrate the “door sensing” function, i.e. the function of automatic detection of the closed door condition of the device according to the embodiment of FIG. 4; in particular, the position of the sensing lever visible in FIG. 8, corresponding to an open door condition, corresponds to an open circuit state visible in FIG. 8A, while the position of the sensing lever visible in FIG. 9, corresponding to a closed door condition, corresponds to a closed circuit state visible in FIG. 9A;

FIGS. 10 and 11 illustrate the movement along the longitudinal direction of the pusher which determines the automatic opening function of the door at the end of the washing cycle; specifically in FIG. 10 the pusher has not yet rotated the closing element and therefore the door is still closed, while in FIG. 11 the pusher has rotated the closing element and the door is open;

FIGS. 12 to 14 illustrate the operation of the anti-tampering function, i.e. anti-tampering of the device according to the present invention in accordance with the first embodiment;

FIGS. 15 to 29 illustrate the operation of the device according to the present invention in accordance with a first embodiment according to the “safety-system” feature, i.e., safety in the event of various incorrect operations carried out by the user when closing the door of the appliance;

FIG. 30 illustrates an exploded view of the opening and closing device of a dishwasher door according to the present invention in accordance with a second embodiment in which the sensing lever of the first embodiment is replaced by a linear actuator;

FIGS. 31 and 32 illustrate the “door sensing” function, i.e., the automatic detection of the closed condition of the door of the device, according to the present invention in accordance with the embodiment of FIG. 30 in which the function is delegated to a linear sliding element;

FIG. 33 illustrates an exploded view of the opening and closing device of a dishwasher door according to the present invention in accordance with a third embodiment in which an electric actuator is present to perform the “auto-opening” function of the appliance door;

FIGS. 34-35 illustrate the step of manual closing of the door by the user with consequent activation of the “door sensing” element;

FIG. 36 illustrates a “pull-to-open” opening condition in which the user, by applying a pulling force to the door, causes the door to open by overcoming the resistance of the torsion spring attached to the closing hook;

FIG. 37 shows how, starting from the condition of an open door and open electrical circuit in FIG. 34, closing the door activates the sensing lever which closes the electrical circuit allowing current to flow;

FIG. 37 furthermore shows also how the closing of the door and the movement of the sensing enables the reading of the magnetic field variation on the Hall sensor, which determines the reference value for detecting the displacement of the sensing sensor;

FIG. 38 shows how, when the door is pressed, the pin causes an additional displacement of the sensing sensor whose overrun is detected by the Hall sensor which activates the electric actuator for automatic door opening;

FIGS. 39 and 40 show the actuation of the pusher which causes the closing hook to rotate, pushing the door pin outwards and causing the door to open;

FIGS. 41 to 43 illustrate the anti-tampering function of the device according to the present invention in accordance with the third embodiment described;

FIGS. 44 to 47 illustrate the “safety” function that ensures the integrity of the device according to the present invention in case of events that could lead to damage to the device.

### DETAILED DESCRIPTION OF THE INVENTION

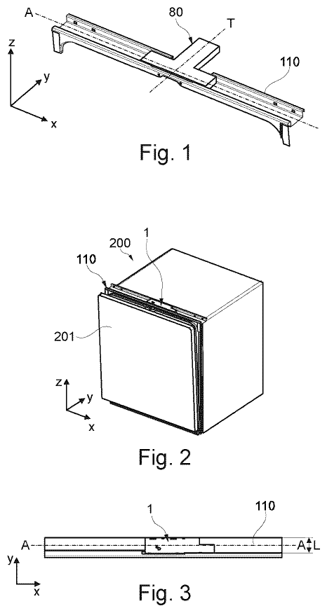

With particular reference to the attached FIG. 1, manufacturers of household appliances, and in particular dishwashers, require component suppliers to provide door opening and closing devices suitable for being housed in the upper cross member 110 of the frame of the appliance 200.

Opening and closing devices of a type known from the state of the art, however, cannot be housed completely within the cross member 110 because they have a transverse footprint, as shown in FIG. 1, where the footprint of a device of a known type 80 is schematically represented.

With reference to the Cartesian tern indicated in FIG. 1, the footprint in the transverse direction of the closing unit of the known type 80 is due to the need to perform the “automatic opening” function by means of an actuator which, in devices of known type, rests directly on the striker pin, or directly on the door, exerting directly on said pin a thrust in the direction Y, i.e., in the direction of the transverse axis T of the cross member 110, perpendicularly to the longitudinal axis A of the cross member 110, which extends in the direction X of FIG. 1, causing the striker pin to move away from the closing unit and, therefore, the opening of the door 201.

Having to provide a pusher element that pushes the striker pin in the direction Y transverse to the longitudinal extension of the cross member, known closing devices and/or systems generally have a footprint that is not suitable for being contained within the width L of the cross member 110 of the frame, thus protruding from it in the transverse direction.

The device 1 for opening and closing the door of a household appliance, in particular of a dishwasher, according to the present invention, is instead configured in such a way that its closing unit 50 can be housed completely within the cross member 110 of the frame of the household appliance, having not only a substantially longitudinal development but also an overall cross-sectional footprint compatible with the width L of the cross member 110, as shown by way of example in FIGS. 2 and 3.

In this way, the device 1 according to the present invention can be housed completely within the longitudinal extension of the cross member 110 without protruding transversely therefrom, with the advantages in terms of increased robustness of the appliance frame already described above.

In order to achieve this technical result, i.e. to drastically reduce the cross-sectional dimension of the device, and in particular of its closing unit 50, so as to make it compatible with the dimension L of the width of the cross member, and at the same time perform the pull-to-open feature, the opening and closing device 1 of the door 201 of a dishwasher 200 in accordance with a first embodiment of the present invention had to solve the technical problem of performing the self-opening function, which provides for exerting on the striker pin integral with the door a thrust in the direction Y substantially perpendicular to the longitudinal direction X of the cross member 110 in the direction of moving the pin away from the cross member, at the same time containing the transverse footprint of the device itself.

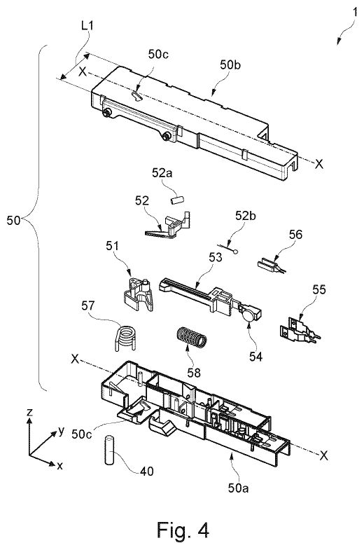

In order to obtain the self-opening functionality with a reduced cross-sectional dimension, with particular reference to the exploded view of FIG. 4 the opening and closing device of 1 the door 201 of a household appliance, in particular of a dishwasher 200, in accordance with a first embodiment of the present invention comprises a closing (and opening) unit 50 adapted to retain in closing and release in opening a striker pin 40 which will be associated with the door 201 of the dishwasher.

Still with reference to the exploded view of FIG. 4, the closing unit 50 in accordance with said first embodiment will advantageously comprise a containment body 50a, 50b substantially box-shaped with prevalent longitudinal extension X in turn preferably comprising a lower containment body 50a, configured to house the components of the unit, closed at the top by a cover 50b. The terms upper and lower are defined with reference to the direction of the vertical axis Z of the tern of axes visible in FIGS. 1, 3 and 4. The direction X of the tern in FIG. 4 is therefore the longitudinal direction, oriented according to the direction of the longitudinal axis A of the cross member 110 with which said device 1 will be associated.

Again with reference to the exploded view of FIG. 4, said closing unit 50 of the device 1 for opening and closing the door 201 of a dishwasher 200 in accordance with a first embodiment of the present invention further comprises at least one closing element or wheel 51 associated with an elastic element 57, advantageously comprising a torsion spring 57, and comprising a seat 51a suitable for accommodating said striker pin 40. Advantageously, said housing 51a is delimited by an upper spout 51a′ and a lower spout 51a″, and said closing element 51 is associated at the pin 51b with said containment body 50a, 50b of said closing unit 50, in particular by means of guide grooves 50c adapted to accommodate the lower ends, in the lower containment body 50a, and the upper ends, in the cover 50b, of said pin 51b of said closing element 51.

Further, in accordance with a first embodiment the device 1 according to the present invention comprises detection or sensing means 52 advantageously comprising at least one sensing lever 52 with which a return spring 52a is associated, said sensing lever 52 being adapted to contact a sensing spring 52b with which sensing tabs 50c are associated.

Said closing element or wheel 51 is movably associated with said containment body 50a, 50b with its pin 51b being inserted within said guide grooves 50c so as to be able to rotate and translate with respect to said containment body 50a, 50b.

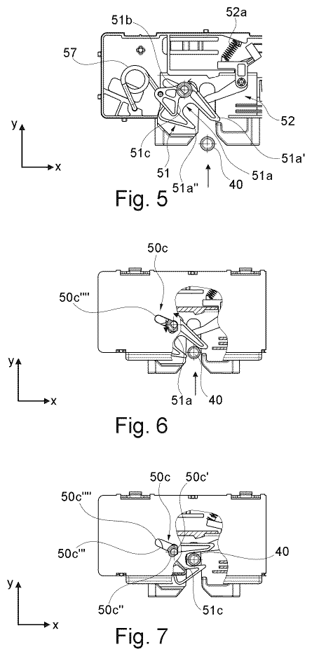

More particularly, with reference, for example, to FIGS. 5 to 7, each of said guide grooves 50c comprises a first portion having a vertical wall section 50c′, i.e., directed in the transverse direction indicated by the axis Y in the Figures a lower recess 50c″, and a straight section inclined 50c″′ at an angle to the longitudinal X and transverse directions Y and terminating with an end stop 50c″′.

The operation according to the pull-to-open function of the device 1 for opening and closing the door 201 of a dishwasher 200 according to the present invention is illustrated in FIGS. 5 to 7.

FIG. 5 shows the device 1 according to the invention in an open door condition. Note the striker pin 40 which is positioned outside the seat 51a of the closing element or wheel 51.

When the user closes the door, he/she causes the striker pin 40 to move against said closing element 51, as shown in FIG. 6, and must impart a certain force, sufficient to overcome the resistance of the elastic element or torsion spring 57, to cause the rotation of the closing element around its own pin 51b of the wheel 51 in the anti-clockwise direction indicated by the arrow in FIGS. 5 and 6.

Continuing the door-closing movement, said closing element or wheel 51, in addition to rotating about the axis of said pin 51b, translates downwards along the first vertical wall section 50c′, according to the arrow visible in FIG. 6. Having reached the end of the lower recess 50c″, as shown in FIG. 7, it is no longer necessary for the user to push the door, as it is the closing element 51, under the action of the torsion spring 57, that exerts a pull on the striker pin 40 in the direction of the axis Y and brings the dishwasher door into the closed position.

FIG. 7 illustrates the closed door condition: the torsion spring 57 imparts a force to the closing element or wheel 51 that does not allow the door to open spontaneously. The user, imparting a pulling force, must overcome the force of the torsion spring 57 to open the door.

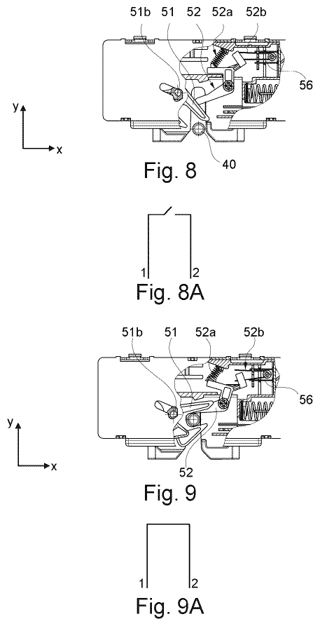

With particular reference to FIGS. 8, 8A, 9 and 9A, the “door sensing” function will now be illustrated, i.e. the function of automatically detecting the closed condition of the door in accordance with the first embodiment of the device according to the present invention.

With reference to FIG. 8, when the door is open and the closing element 51 is in the rest position shown in FIG. 8, the detection or sensing lever 52 with which a return spring 52a is associated and which contacts a sensing spring 52b, is also in the rest position and the spring 52b does not contact the electrical circuit 56 of the appliance which remains open, according to the diagram shown in FIG. 8A.

With reference to FIG. 9, which illustrates a closed door condition, the striker pin 40 causes the clockwise movement of the detection or sensing lever 52, which moves the spring 52b that closes the electrical circuit according to the diagram visible in FIG. 9A allowing the passage of current.

In this way, the appliance can only be started when the door is properly closed.

The closing unit 50 according to the invention further comprises a pusher 53 operatively associated with an actuator 54, which preferably comprises a wax motor, advantageously associated with actuator tabs 55. A return spring 58 of the pusher is also associated with said pusher 53.

The structure of the closing device 1 in accordance with a first embodiment of the present invention is characterised in that said pusher 53 and said actuator 54 are arranged along the longitudinal direction X of said lower containment body 50a, which can thus have a contained transverse footprint L₁, in particular compatible with the width L of the cross member 110, so that said lower containment body 50a, 50b can be completely accommodated within the cross member 110 of the household appliance when installed.

In order to achieve said technical result, said pusher 53 and said actuator 54 are arranged substantially aligned with each other along the longitudinal direction X of the closing unit 50 and the thrust exerted by the actuator 54 when it is actuated is transmitted to the striker pin 40 not directly, but by means of said at least one closing element or wheel 51 adapted to accommodate said striker pin 40.

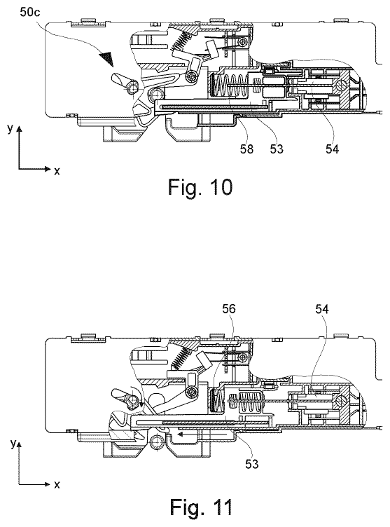

With reference to FIGS. 10 and 11, the operation of the opening and closing device 1 of the door of a dishwasher according to the present invention will now be described according to the feature of automatically opening the door at the end of the washing cycle, also known as the “auto-opening function”.

With particular reference to FIG. 10, it illustrates a closed door condition and lock in working condition: it can be seen that the closing element 51 is in the rest position with its pin 51b positioned in the lower recess 50c″ of the guide groove 50c, and the detection or sensing lever 52 is rotated clockwise by the thrust of the striker pin 40 and, with the sensing spring 52b, closes the electrical circuit 56 permitting the start of the washing programme.

FIG. 11 instead shows the operation of the device 1 according to the “auto-opening” function, i.e. when the control unit of the appliance actuates the actuator 54, advantageously constituted by a wax motor, this axially pushes the pusher 53 which, moving in the longitudinal direction X in the direction of the arrow indicated in FIG. 11, i.e. towards said closing element 51, strikes said striker element 51c causing the clockwise rotation of the closing element 51 to the open position, which allows the expulsion of the striker pin 40 from the seat 51a of said striker element 51c, causing the door to open, which may possibly be facilitated by the presence of unbalanced door hinges, so that the door opening movement is further facilitated or completed by the weight of the door itself.

Thanks to this configuration, which makes it possible to arrange said pusher 53 and said actuator 54 along the longitudinal direction X of said lower containment body 50a, the transverse footprint L₁ of the device according to the present invention is particularly contained, and, in particular, is compatible with the width L of the cross member 110, so that said lower containment body 50a, 50b can be completely accommodated within the cross member 110 of the household appliance when installed.

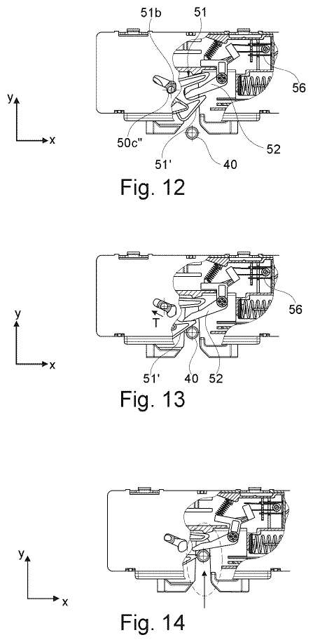

With particular reference to FIGS. 12 to 14, the operation of a device for opening and closing 1 the door of a dishwasher will now be illustrated in accordance with a first embodiment of the present invention according to the anti-tampering feature.

FIG. 12 shows a locking condition in which tampering thereof has taken place. In particular, said closing element 51 or wheel is in the fully anti-clockwise rotated closing position wherein said striker pin 51b of said closing element or wheel 51 is accommodated in the lower recess 50c″, however, the door is left open because the striker pin 40 is not positioned within the recess 51a of said closing element 51. In this condition, the detection or sensing lever 52 is not rotated clockwise by the contact with the striker pin 40, as is the case in the correctly closed condition of the device shown in FIG. 9, therefore the electrical circuit 56 is not closed and the appliance's washing programme is not allowed to start.

In this condition, as can be seen in FIG. 13, when the user manually closes the door it causes contact between the striker pin 40 and said closing element 51 or wheel, in particular at the inclined outer surface 51′ of said lower spout 51a″ of said closing element 51.

Due to the inclination of the inclined surface 51′ the thrust of the door of the appliance by the user is transformed into a thrust with a horizontal component, i.e. in the direction of the axis X in the Figures, and a vertical component Y, which therefore determines the translation of the pin 51b of the closing element 51 in the direction of the arrow T indicated in FIG. 13, that is, in the direction of the inclined section 50c″′ of the guide groove 50c, and the consequent roto-translation of said closing element 51 with respect to the retaining body 50a, 50b.

Being able to translate along the inclined rectilinear section 50c″′ of the guide groove 50c, and therefore with a longitudinal component in the X direction, the closing element 51 translates in the opposite direction to the direction of the X-axis, allowing the striker pin 40 to slide to the end of the inclined surface 51′. The situation is shown in FIG. 14.

At this point a further thrust of the door causes the pin to pass over the end of the inclined surface 51′ of the closing element 51, and the latter, free to translate again within the guide groove 50c, can be returned, by rotating anti-clockwise driven by the torsion spring 57, to the closed position in which said striker pin 40 is accommodated within the seat 51a.

In this way, the door can be closed and reopened normally.

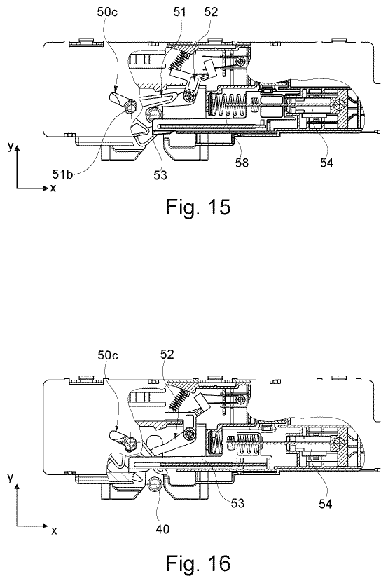

With particular reference to FIGS. 15 to 29, the operation of a device for opening and closing 1 the door of a dishwasher will now be illustrated in accordance with a first embodiment of the present invention according to the “safety-system” feature.

The “safety system” feature comes into operation in several cases that may occur during the life of the device. In fact, it allows the structural integrity of the lock even in the face of the occurrence of events such as, for example:
that as soon as the “auto opening” is finished, the user tries to close the door again without waiting for the lock reset time;
that during auto-opening function the door is blocked by an external force and the opening movement is not possible;
that during the auto-opening function at any time during the action of opening the door the user tries to close it instead.

In these events and others that may occur, the opening and closing device 1 of a dishwasher door according to the present invention ensures the structural integrity of the lock.

Consider, by way of example, that at the end of a washing cycle and having opened the door thanks to the “auto-opening” function, the user tries to re-close the door without waiting for the lock reset time, i.e. when the pusher 53 and said actuator 54 are in the end stop position shown in FIG. 16 corresponding to the open door position at the end of the auto-opening function, without waiting for the actuator 54, preferably consisting of a wax motor, to return to the neutral position of FIG. 15.

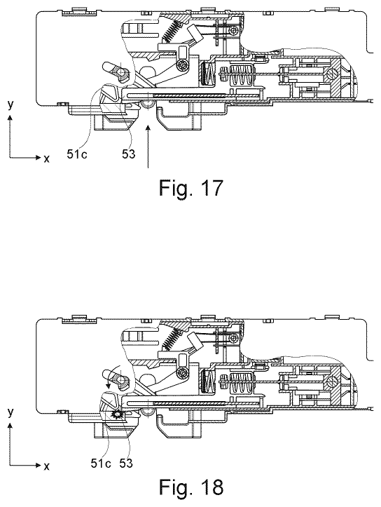

In the event that the user attempts to close the door when the device is in this configuration, the circumstance shown in FIG. 17 occurs, where it can be seen how the striker pin 40 in this case causes the rotation of the closing element or wheel 51 in the anti-clockwise direction until the wheel itself 51, with its striker element 51c, strikes the pusher 54 which is in the extended position, as shown in FIG. 18.

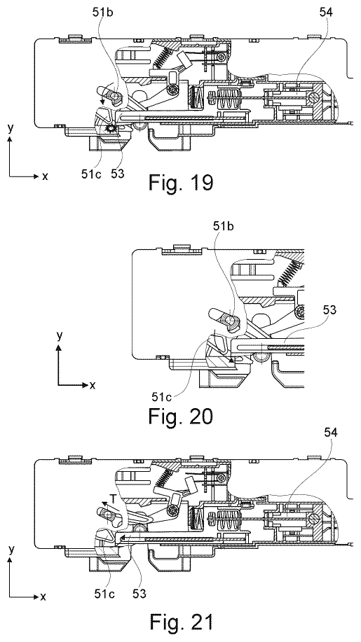

At this point, when the closing element or wheel 51 abuts, with its striker element 51c, against the pusher 53 the point of rotation of said closing element or wheel 51 changes from the rotation pin 51b to the point of contact between the closing element 51 and the pusher 53, as shown in FIG. 19 and the detail of FIG. 20.

By rotating around the point of contact between the closing element or wheel 51 and the pusher 53, the closing element 51 is forced to move in the direction indicated by the arrow T in FIG. 21 within the guide groove 50c, along its inclined straight section 50c′″. In this way, even if the user continues to push the door in an attempt to close the door, the closing movement can continue unimpeded and without stressing the lock components, in particular without stressing the pusher 53 and actuator 54, until the door has reached the closed position, although the pusher 53 and actuator 54 are still in the extended position corresponding to the end of the self-opening function and the lock, and in particular actuator 54, have not yet been reset.

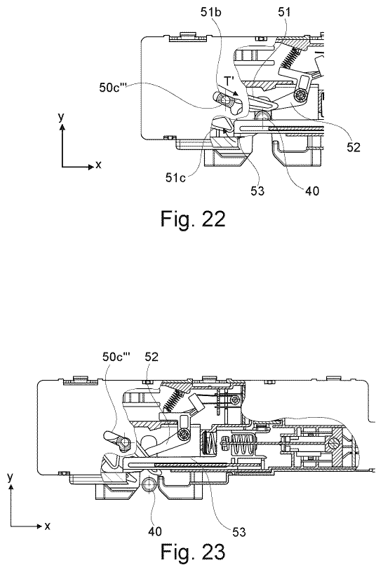

Once the user has finished exerting the pushing action on the door, the closing element or wheel 51, under the effect of the push of the torsion spring 57, the pin 51b will translate in the direction of the arrow T′ of FIG. 22 and the closing element 51 will return to its open position and the door will open.

The door does not therefore remain in the closed position, nor does the device undergo any damage. Once the pusher 53 has returned to its rest position, it will be possible to close and open the door normally. The situation is as shown in FIG. 23.

Another circumstance which could lead to damage of the opening and closing device 1 of the door of a dishwasher according to the present invention occurs when during automatic opening, i.e. during auto-opening, the door is blocked by an external force which prevents the opening movement.

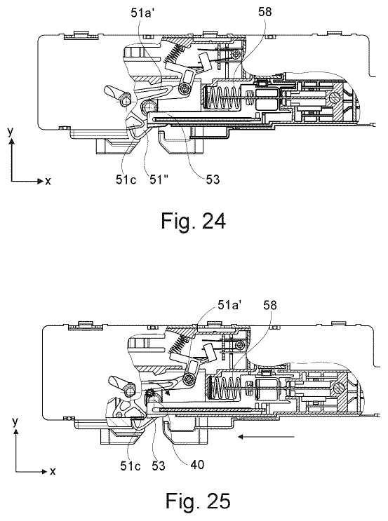

The situation is depicted in FIGS. 24 and 25. In particular, at the end of the washing cycle the dishwasher activates the automatic self-opening function, and the pusher 53 starts its translation movement from the rest position to the extended operating position and abuts the striker 51c of the closing element or wheel 51.

The closing element or wheel 51, under the pushing effect of the pusher 53, begins to rotate in the open position, as shown in FIG. 25. In this case, however, the door is blocked by an external force that keeps it in the closed position. In this case, during its movement, the closing element or wheel 51 will turn with its upper spout 51a′ against the striker pin 40 which will remain stationary in its closed door position since the door opening, as mentioned, is blocked from the outside.

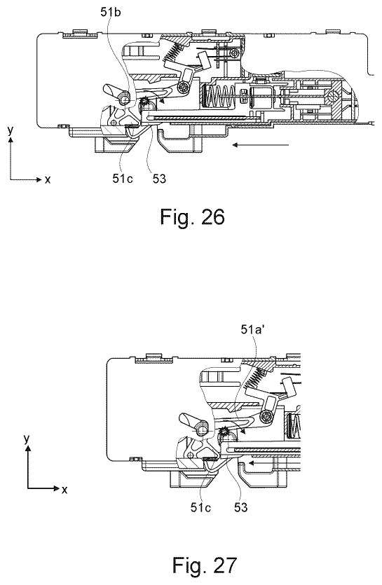

At this point, when the closing element or wheel 51 rotates with its upper spout 51a′ against the striker pin 40 (reference is made to FIGS. 26 and 27) the point of rotation of the closing element 51 itself changes, which will no longer be its rotation pin 51b, but rather the point of contact between the closing element 51 itself and the striker pin 40.

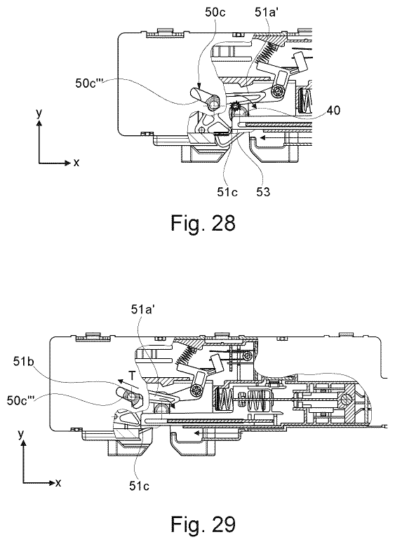

With particular reference to FIGS. 28 and 29, it can be seen that by rotating about the point of contact between the closing element 51 and the striker pin 40, and said closing element 51 still being under the thrust action of the pusher 53 which strikes the striker 51c of the closing element or wheel 51, the closing element 51 is obliged to move by translating along the inclined rectilinear section 50c′″ of the guide groove 50c, according to the direction and sense of the arrow T in FIG. 29.

In this way, the pusher 53 can continue in its pushing action and translation movement without overstressing the components, in particular the actuator 54, thus avoiding the risk of internal breakage of the lock.

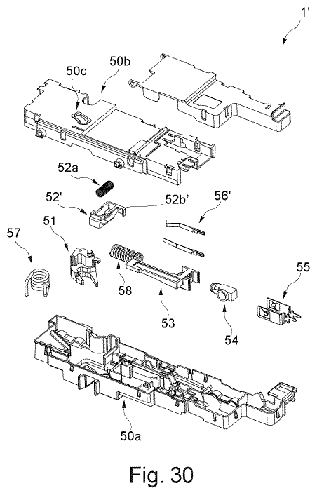

With particular reference to FIG. 30, an alternative embodiment of the opening and closing device 1′ of the door 201 of a dishwasher 200 according to the present invention will now be illustrated in which the detection or sensing means comprise, instead of the detection or sensing lever 52 equipping the first embodiment described above with reference to FIGS. 4 to 29, a sliding element or slider 52′ adapted to be actuated by the pin 40 of the door of the household appliance against the action of a return spring 52a′ acting between said sliding element 52′ and the containment body 50a, 50b.

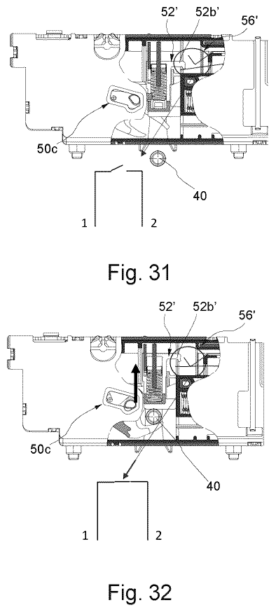

With particular reference to FIGS. 31 and 32, in accordance with this second alternative embodiment of the opening and closing device 1′ according to the present invention the sensing slider 52′ is moved along the transverse direction Y by the pin 40 of the appliance door which is pushed closed by the user.

As can be seen in FIG. 31, when the appliance door is open the sensing slider 52′ keeps the electrical circuit open thanks to the action of a push arm 52b′ acting against the slats 56′, in particular against the lower slat 56b′ which are connected to the contacts 55 of the electrical circuit, thus keeping the electrical circuit open.

When the door is closed, as shown in FIG. 32, the pin 40 of the door causes the sensing slider 52′ to retract, causing the electrical circuit to close and allowing current to flow and the appliance to start.

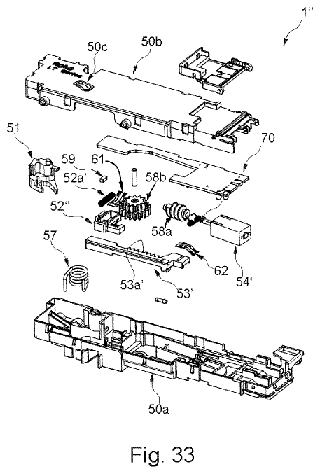

With particular reference to FIG. 33 et seq., a further embodiment of the device for opening and closing 1′ the door 201 of a dishwasher 200 according to the present invention will now be illustrated in which the pusher 53′ is moved by an electric actuator 54′.

More specifically, with reference to the exploded view of FIG. 33, the actuator 54′ is constituted by an electric motor preferably adapted to drive in rotation a worm screw 58a which in turn drives a transmission and reduction gear 58b which drives in translation the pusher 53′ which in this embodiment is advantageously provided with a rack 53a′ adapted to engage with said transmission and reduction gear 58b.

Furthermore, in accordance with a further preferred embodiment of the present invention, the closing unit 50′ further comprises a PCB indicated in FIG. 33 by reference number 70, and said sensing slider 52″ is advantageously equipped with a magnet 59 configured to interact by Hall effect with said PCB 70.

Advantageously, the device for opening and closing 1 the door 201 of a dishwasher 200 according to the present invention in accordance with the embodiment shown in FIG. 33 et seq. further comprises a first contact element 61, preferably in the form of metal slats, adapted to detect the position of the sensing slider 52″ and a second contact element 62, preferably in the form of metal slats, adapted to detect the position of the pusher 53′.

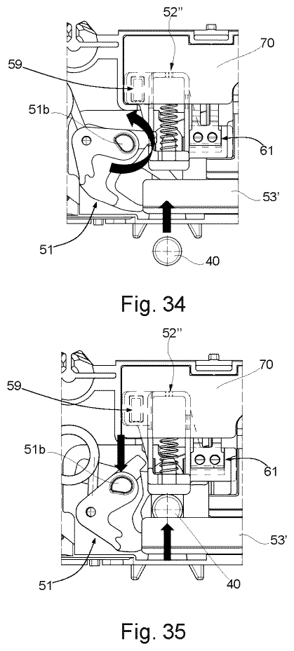

With particular reference to FIG. 34, a condition is shown in which the user manually closes the door 201 of the appliance by causing the pin 40 to be pushed against the closing element or wheel 51 which rotates in the anti-clockwise direction of the arrow shown in the figure.

Continuing the closing movement of the door 201, FIG. 35, the wheel 51 not only rotates but also translates with its pin 51b guided along the guide groove 50c, as described above at this point it is the wheel 51 under the action of the torsion spring 57 that brings the door into the closed position.

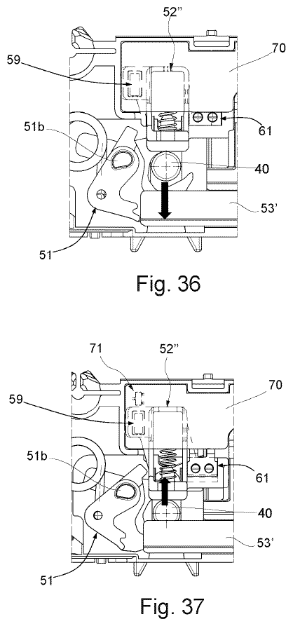

As can be seen in FIG. 36, when the door is in the closed position, the torsion spring 57 imparts a force to the closing element 51 which does not allow spontaneous opening, but opening by the user is permitted following the application of a sufficient tensile force, sufficient to overcome the force of the torsion spring 57. The “pull-to-open” function is thus performed.

With particular reference to FIG. 37, when the door is closed the pin 40 of the door 201 of the dishwasher pushes the sensing slider 52″ closing the electrical circuit by means of the first contact element 61 running on the tracks of the PCB 70 closing the circuit and allowing the passage of current.

The PCB 70 “reads” the position of the door by detecting the change in the magnetic field through the interaction between the Hall sensor-indicated in FIG. 37 generically with the reference number 71-positioned on the PCB 70 and the magnet 59 positioned on the sensing cursor 52″.

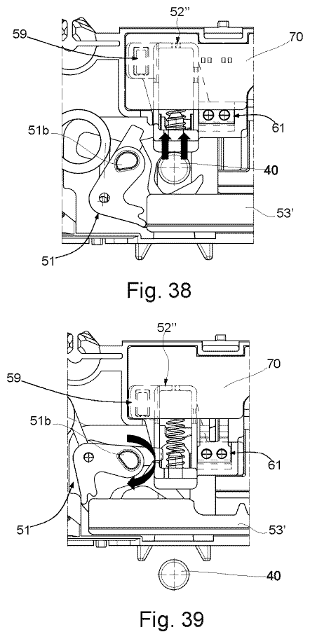

As shown in FIG. 38, when the user presses on the door 201 again, the pin 40 pushes the sensing slider 52″ causing it to move back one extra stroke from the position the slider assumes in the closed door condition. The overrun of the sensing slider 52″ is detected by the Hall sensor, which detects a change in the magnetic field with respect to the closed door condition (and door not pressed) and activates the pusher 53′ to automatically open the door, thus realising the “pull-to-open” function.

In the embodiment shown in FIG. 33 and followings, the Hall sensor activates the electric motor 54′ and the worm screw 58a, which rotates the gear 58b which causes the translation of the pusher 53′, as visible in FIG. 39, and determines the rotation of the striker 51c of the closing element 51 which rotates pushing outwards the pin 40 of the door 201.

As can be seen preferably the pusher 53′ acts on the striker 51c of the closing element 51 and not on the closing element itself.

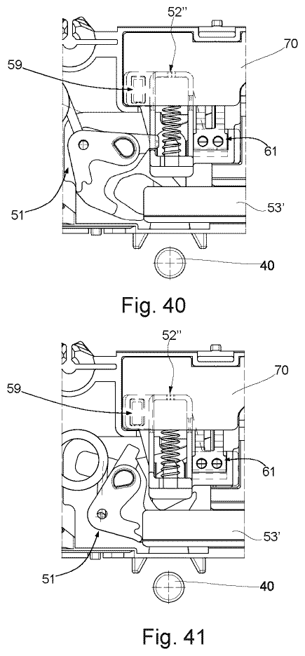

FIG. 40 shows an open door condition (note the pin 40 now ejected from the closing element) while the pusher 53′ is moved away from the striker 51c of the closing element 51 by the electric motor 54′ which reverses the direction of rotation of the worm screw 58a.

Advantageously, also on the pusher 53′ there is a second contact element 62, preferably in the form of metal slats, which interacts with said PCB 70 enabling the position of the pusher 53′ to be detected.

The “anti-tampering” feature of the device 1″ according to the present invention will now be illustrated.

FIG. 41 shows a condition of a tampered device due to improper use, in which in particular the wheel 51 is in the closed position while the door 201 has remained open, and the pin 40 is therefore not retained by the wheel itself.

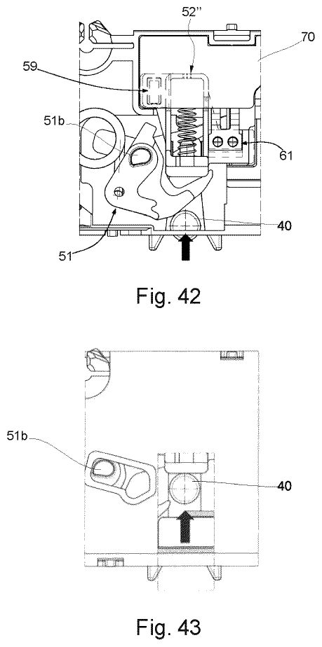

When the user attempts to close the door 201 anyway, the situation illustrated in FIG. 42 occurs: the pin 40 meets the wheel 51 at the section of the hook with the inclined plane 51d. By imposing a certain force on the door, the user causes the wheel 51 to move inside the guide groove 50c of the containment body 50a, 50b, as shown in FIG. 43, and to rotate until the pin 40 passes the end of the hook 51 and advances into its seat, allowing the door to close and the sensing slider 52″ to retract. The door 201 can now be reopened normally.

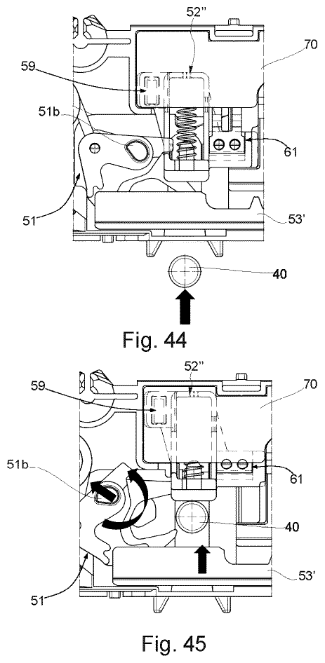

With particular reference to FIGS. 44 to 47, the safety function or “safety system function” will now be illustrated.

As mentioned above, the safety function comes into operation in various situations that could occur during the operation of the opening and closing device 1′, 1″ according to the present invention. This safety system guarantees the structural integrity of the device even in the face of such situations. For example, if as soon as the “auto-opening function” is finished, the user tries to close the door without waiting for the lock reset time; or if during the “auto-opening function” the door is blocked by an external force and the opening movement is not possible; or if during the “auto-opening function” at any time during the door opening action the user tries to close the door.

In all these and other circumstances that might occur, the structural integrity of the lock must be guaranteed, and this guarantee is provided by the safety system.

With particular reference to FIG. 44, when the “auto-opening” function has just ended, the user tries to close the door 201 again without waiting for the reset time of the lock, and therefore without waiting for the pusher 53′ to return to the rest position, by closing the door, the pin 40 of the appliance door causes the closing element 51 to rotate, which, however, during the closing movement will encounter the pusher 53′.

The closing element or wheel 51 will then move along the guide groove 50c of the containment body 50a, 50b, as shown in FIG. 45, without the device components being stressed.

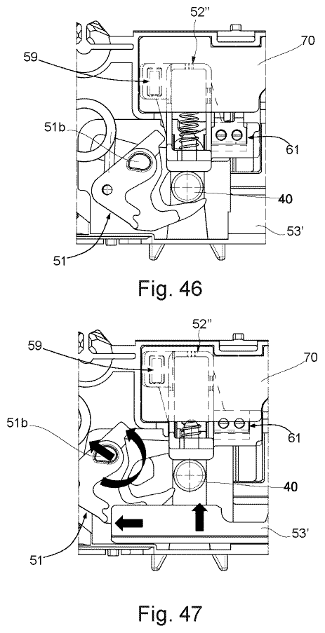

With reference to FIG. 46, we will now illustrate a situation in which during automatic door opening according to the “auto-opening” function, the opening of the door is blocked by an external force that does not allow the opening movement to continue.

As illustrated by the arrows in FIG. 47, by rotating around the contact point between the wheel 51 and pin 40 and under the pushing action of the pusher 53′, the wheel 51 is forced to translate along the guide groove 50c. In this way, the pusher 53′ continues in its pushing action on the striker 51c of the closing element 51 without overstressing the components with the risk of internal breakage of the lock. It has thus been shown how the device for opening and closing 1, 1′, 1″ the door 201 of a dishwasher 200 according to the present invention achieves the intended task and purposes.

In particular, it has been shown that the device 1, 1′, 1″ according to the present invention is capable of performing the function of automatic opening (auto-opening) by exerting a pushing action on the striker pin 40 of the door 201 of a dishwasher 200 while at the same time containing the overall transverse footprint of the device itself, so that this transverse footprint is compatible with the width L₁ of the cross member 110 of the frame of a dishwasher 200.

Furthermore, it has been shown that the opening and closing device 1, 1′, 1″ of a dishwasher door according to the present invention is capable of operating the “pull-to-open” feature without requiring excessive force from the user in closing the door, and that it is particularly reliable in that it avoids the risk that the push operated by the user may damage the components of the device.

Moreover, it has been shown that the opening and closing device 1, 1′, 1″ of a dishwasher door according to the present invention is capable of operating at the same time the “door-sensing” feature, i.e., door-opening detection, the “auto-opening” feature i.e., automatically opening the door at the end of the washing cycle, the “anti-tampering” feature, i.e., anti-tampering, as well as the “safety” feature, i.e., a safety feature which prevents damage to the device itself in case the user tries to close the door of the household appliance without waiting for the reset time of the lock.

Furthermore, it has been shown that the opening and closing device 1″ of a dishwasher door according to the present invention, particularly in the embodiments illustrated in FIGS. 33 to 47, is capable of operating the “push-to-open” feature.

The device for opening and closing 1 the door 201 of a dishwasher 200 according to the present invention is also susceptible to modifications and variations, all of which are within the scope of the invention as defined by the appended claims.

1. A device for opening and closing the a door (201) of a dishwasher (200), said device (1) comprising:
a closing unit (50) adapted to be associated to a cross member (110) having a prevalently longitudinal extension (A), of a frame of said dishwasher (200) and configured to accommodate a striker pin (40) associated with said door (201) of said dishwasher (200),
wherein said closing unit (50) comprises a box-shaped containment body (50a, 50b) with a prevalently longitudinal axial extension (X) adapted to be installed within said cross member (110) and to accommodate said striker pin (40) according to a closing movement direction along a transverse direction (Y) substantially orthogonal to the axial direction (X) of said box-shaped containment body (50a, 50b),
wherein said box-shaped containment body (50a, 50b) accommodates therein a closing element (51) movable in rotation between a closing position, in which the closing element retains said striker pin (40), and an opening position, in which the closing element releases said striker pin (40), and
wherein said closing element (51) is operatively associated with an elastic element (57) acting between said closing element (51) and said containment body (50a, 50b),
said device further comprising a pusher (53) movable by an actuator (54) along said longitudinal direction (X) of said containment body (50a, 50b) and adapted to abut a striker element (51c) provided on said closing element (51), said pusher (53) being movable along said longitudinal direction (X) between a non-extended rest position and an extended operating position in which said pusher exerts a thrust on said striker element (51c) causing a rotation for opening said closing element (51) and a movement for opening the pin along the transverse direction (X),
wherein said containment body (50a, 50b) further comprises guide grooves (50c) within which a closing pin (51b) of said closing element (51) is rotatable and slideable,
further comprising sensing means (52, 52′, 52″), to which a return spring (52a) is associated, said sensing means (52, 52′, 52″) being adapted to selectively close an electrical circuit (56, 56′) of the dishwasher so as to start a washing cycle following a movement of said sensing means (52, 52′, 52″) by said striker pin (40) when said striker pin (40) is moved to a position corresponding to a closed door condition (201).

2. The device for opening and closing a door (201) of a dishwasher (200) according to claim 1, wherein said sensing means comprise a rotatable lever (52) configured to be rotated by a pushing action of said striker pin (40) of the door (201) when the door is pushed closed by a user.

3. The device for opening and closing a door (201) of a dishwasher (200) according to claim 1, wherein said sensing means comprise a translatable slider (52′), configured to be translated by a pushing action of said striker pin (40) of the door (201) when said door is pushed closed by a user.

4. The device for opening and closing a door (201) of a dishwasher (200) according to claim 1, wherein said box-shaped containment body (50a, 50b) with a prevalently longitudinal extension (X) comprises a lower containment body (50a) configured to house components of the closing unit (50) and a closing cover (50b), said lower containment body (50a) and said closing cover (50b) each comprising one of said guide grooves (50c) for accommodating one end, respectively lower and upper, of said closing pin (51b) of said closing element (51).

5. The device for opening and closing a door (201) of a dishwasher (200) according to claim 4, wherein each of said guide grooves (50c) comprises a first portion having a vertical wall section (50c′) directed in the transverse direction (Y) of the device, a lower recess, and a straight section (50c′″) inclined in an oblique direction with respect to the longitudinal (X) and transverse (Y) directions of the device and terminating with an end stop (50c″″).

6. The device for opening and closing a door (201) of a dishwasher (200) according to claim 5, wherein said lower end and said upper end of said pin (51b) of said closing element (51) are movable between said lower recess of said grooves (50c), within which said closing pin (51b) can rotate about an axis thereof so as to allow a rotation about axis of said pin (51b) of said closing element (51), and the upper end of said vertical wall section (50c′), from which said pin (51b) can translate within said inclined straight section (50c″′) until it reaches the end stop (50c″″).

7. The device for opening and closing a door (201) of a dishwasher (200) according to claim 1, wherein said closing element (51) comprises a seat (51a) adapted to receive said striker pin (40) and delimited by an upper spout (51a′) and a lower spout (51a″), said lower spout (51a″) having an inclined outer surface (51′).

8. The device for opening and closing a door (201) of a dishwasher (200) according to claim 1, wherein said closing element (51) is movable with a selective rotational and translational movement with respect to said box-shaped containment body (50a, 50b) under the action of said pusher (53) and, selectively, of said striker pin (40).

9. The device for opening and closing a door (201) of a dishwasher (200) according to claim 1, wherein said actuator (54, 54′) of said pusher (53) is a wax actuator (54) or an actuator comprising a shape memory material (SMA) or a bimetal, whose activation is controlled by a control circuit of the dishwasher.

10. The device for opening and closing a door (201) of a dishwasher (200) according to claim 1, wherein said actuator of said pusher (53) comprises an AC or DC electric motor (54′) whose activation is controlled by a control circuit of the dishwasher.

11. The device for opening and closing a door (201) of a dishwasher (200) according to claim 10, wherein said AC or DC electric motor comprises a worm gear (58a) adapted to move a transmission and reduction gear (58b) which, in turn, moves in translation the pusher (53′), which comprises a rack (53a′) adapted to engage with said transmission and reduction gear (58b).

12. The device for opening and closing a door (201) of a dishwasher (200) according to claim 1, further comprising a printed circuit board PCB (70), and wherein said sensing means (52″) comprises at least one magnet (59) configured to interact by Hall effect with said PCB (70).

13. The device for opening and closing a door (201) of a dishwasher (200) according to claim 1, further comprising a first contact element (61), adapted to detect a position of the sensing means (52″), the sensing means being configured as a sensing cursor, and a second contact element (62), adapted to detect a position of the pusher (53′).

14. The device for opening and closing a door (201) of a dishwasher (200) according to claim 1, wherein the sensing means are configured as a sensing cursor, wherein said sensing cursor (52″) is arranged to make an overrun and an extra-stroke with respect to a position that said sensing cursor assumes in a closed door condition (201), said overrun of said sensing cursor (52″) being detected by a Hall sensor which detects a variation of a magnetic field with respect to the closed door condition and activates, with said actuator (54′), the pusher (53′) for an automatic opening of the door, performing a “pull-to-open” function.

15. The device for opening and closing a door (201) of a dishwasher (200) according to claim 1, wherein a footprint (L₁) in the transverse direction (Y) of the containment body (50a, 50b) is less than a width (L) of the cross member (110), so that said device (1) can be completely housed within the cross member (110) of the dishwasher when installed.
